(19) United States
(12) Patent Application Publication
(10) Pub. No.: US 2023/0028639 A1
(43) Pub. Date: Jan. 26, 2023

(54) Smart Gloves

(71) Applicant: Xiaowu Wu, Shenzhen (CN)

(72) Inventor: Xiaowu Wu, Shenzhen (CN)

(21) Appl. No.: 17/382,320

(22) Filed: Jul. 21, 2021

(51) Int. Cl. G06F 3/01; G09G 3/14; G06F 3/02; G08B 5/22; H04W 4/80; H02J 7/00; A41D 19/00

(52) U.S. Cl. CPC G06F 3/014; G09G 3/14; G06F 3/02; G08B 5/22; H04W 4/80; H02J 7/0047; H02J 7/0045; A41D 19/0024; G09G 2370/06; G09G 2370/16

(57) ABSTRACT

The invention discloses a smart glove, which relates to a smart glove that can be used indoors and outdoors. It includes a glove body. The glove body includes a wrist, a palm, and a finger. On the back of the wrist, there are a switch button, a charging interface, and a control. The control box contains a rechargeable lithium battery and a controller, and the charging interface is electrically connected to the lithium battery in the control box; an LED display is installed on the back of the palm, and the inside of the LED display is electrically connected to the driver of the LED display; The back finger part can wrap all fingers or part of the fingers to protect the skin; on the one hand, the present invention can serve as a warning when the user is walking or riding, improving travel safety, and on the other hand. Play a role in display and publicity.

### TECHNICAL FIELD

The invention relates to a smart glove, and relates to a smart glove that can be used indoors and outdoors.

### BACKGROUND

Traditional gloves are mainly used for hand warming or labor protection, such as the necessary insulation in cold areas, or medical antibacterial and industrial protection, etc. The application of gloves is more and more common; but with the continuous development of science and technology, People's demand for life continues to increase, and single-function gloves will become inconvenient. For example, in cold winter nights, outdoor cyclists wearing thick gloves or pedestrians are outdoors, how to efficiently remind passing vehicles and pedestrians Paying attention to yourself is the key to improving your own safety. At present, there are some improved technologies. The turning indicator of riding is installed on the gloves to indicate the direction of travel, but this function is far from enough; at the same time, with With the advent of the self-media era, people increasingly prefer personal communication methods, that is, to use modern and electronic means to deliver normative and non-normative information to unspecified most people or specific individuals, Use modern technology to display personalized and cool content to others, and solve the problem of traditional gloves with single function and no cool display and content promotion.

### SUMMARY

In order to overcome the shortcomings of the prior art, the present invention discloses a smart glove, and specifically relates to a smart glove that can be used indoors and outdoors.

1. A smart glove, including a glove body, which includes a wrist, palm and fingers. On the back of the wrist, there is a switch button, a charging interface and a control box. The control box contains a rechargeable lithium battery and a controller for charging The interface is electrically connected to the lithium battery in the control box; an LED display is installed on the back of the palm, and the inside of the LED display is electrically connected to the driver of the LED display; the fingers can be wrapped around all fingers after wearing, or can be wrapped A part of the fingers are used to protect the skin; on the one hand, the present invention can play a warning role when the user is walking or riding, and improve the safety of travel, on the other hand, it can play a role of display and publicity.

2. The smart glove according to claim 1, characterized in that: the glove body is composed of multi-layer materials such as glove surface cloth/leather and inner wool cotton.

3. The smart glove according to claim 1, characterized in that: the switch button is used to control the on/off of the entire smart glove and the switching of the LED display pattern; the switching of the LED display pattern refers to through the switch Press the button to select a variety of patterns in the functional mode of the smart glove; the functional modes include warning, propaganda and atmosphere; the user selects the functional mode through the mobile phone APP, and customizes the multiple pattern types in this mode, For the user to enter the pattern selection of the LED display screen through the switch button.

4. The smart glove according to claim 1, wherein the charging interface is used to connect an external power source to complete the charging of the rechargeable lithium battery, and at the same time, data can be sent and received.

5. The smart glove according to claim 1, wherein the rechargeable lithium battery supplies power to the control circuit of the smart glove.

6. The smart glove according to claim 1, characterized in that: the controller is composed of modules such as a Bluetooth transceiver circuit, a charging circuit, a main control circuit, etc., for receiving and processing user data, and at the same time controlling the display of the LED display, And store user-defined patterns; the Bluetooth transceiver circuit is used to communicate with the mobile phone, receive data and control commands issued by the mobile phone APP, and forward the data to the main control circuit; the charging circuit is used to control the The charging of the rechargeable lithium battery; the main control circuit parses the data forwarded by the Bluetooth transceiver circuit and controls it according to user commands, and at the same time sends the decoded display data to the LED drive circuit.

7. The smart glove according to claim 1, wherein the LED display screen is composed of LED lamp beads, which can display time information, warning characters, direction characters, patterns, and the like.

8. The smart glove according to claim 1, wherein the driving circuit of the LED display screen converts the display data received from the main control circuit into an LED display sequence, and then drives each of the LED display screens, LED lamp beads, to achieve the effect of displaying text and patterns.

In addition to meeting the most basic warmth requirements, the smart glove of the present invention also adds three functions of warning, propaganda and atmosphere. Different functions can be selected through the mobile phone APP to realize the functions of warning and display, thereby meeting the needs of different scenes and applications. Very extensive.

The user can download a variety of patterns to the smart glove through the mobile phone APP, and then switch the pattern through the glove button, which is convenient and fast, and can customize pictures and texts for personalized display; also can send pictures or commands wirelessly Smart gloves enable the gloves to quickly respond to commands and display pictures.

### DESCRIPTION OF DRAWINGS

The present invention will be further described below in conjunction with the accompanying drawings and embodiments. In the accompanying drawings:

FIG. 1 is a block diagram of the smart glove of the present invention.

### DETAILED DESCRIPTION

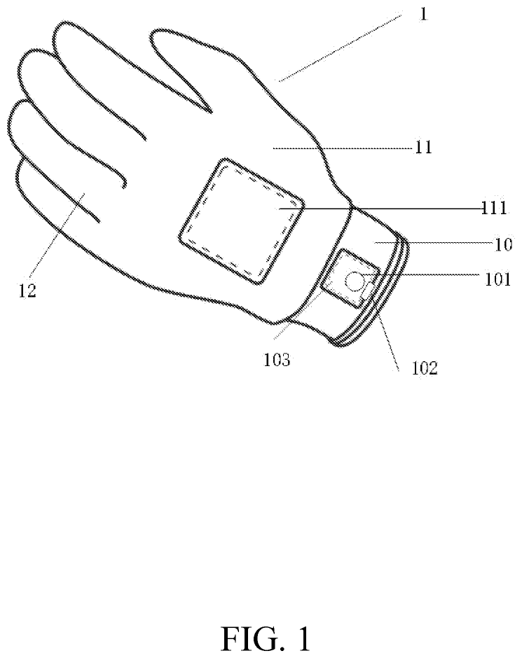

1. As shown in FIG. 1, the smart glove of this embodiment includes: a glove body 1, which includes a wrist portion 10, a palm portion 11, and a finger portion 12. There is a switch button 101 and a charging interface 102 on the back of the wrist portion 10 And the control box 103, the control box 103 contains a rechargeable lithium battery and a controller, and the charging interface 102 is electrically connected to the lithium battery in the control box 103; an LED display 111 is installed on the back of the palm 11, and the internal power of the LED display 111 is The driver of the LED display screen is sexually connected; the finger part 12 can wrap all fingers or part of the fingers to protect the skin; on the one hand, the present invention can play a warning role when the user is walking or riding, and improve travel On the other hand, it can play a role in display and publicity.

2. The smart glove according to claim 1, characterized in that: the glove body 1 is composed of multi-layer materials such as glove surface layer cloth/leather and inner layer woolen cotton.

3. The smart glove according to claim 1, characterized in that: the switch button 101 is used to control the on/off of the entire smart glove and the switching of the LED display pattern; the switching of the LED display pattern refers to through the The switch button 101 selects a variety of patterns in the functional mode of the smart glove; the functional modes include warning, propaganda, and atmosphere; the user selects the functional mode through the mobile phone APP, and customizes multiple patterns in this mode Pattern type, for the user to switch the LED display pattern through the switch button 101.

For example: when the user is walking or running at night, or during outdoor activities such as cycling, the user can set the warning mode through the mobile phone APP, and select the warning picture through the switch button 101. The warning picture can be a turn or a U-turn, Walking, running and other icons or text. At this time, the LED display 111 will continue to flash the warning pictures at regular intervals to indicate vehicles and passers-by on the road, thereby improving the safety of traveling users; at the product exhibition, The user puts on the smart glove 1 and presses the switch button 101, sets it to the publicity mode through the mobile phone APP, and selects the picture to be promoted through the switch button 101. At this time, the LED display 111 will The pictures are scrolled and displayed; in various dating activities, the user puts on the gloves and sets the atmosphere mode through the mobile phone APP, and selects the atmosphere picture through the switch button 101. At this time, the LED display 111 will play the atmosphere picture in a loop, At the same time, users can set up various cool pictures and texts to show themselves.

4. The smart glove according to claim 1, characterized in that: the charging interface 102 is used to connect an external power source to complete the charging of the rechargeable lithium battery, and at the same time, it can send and receive data.

5. The smart glove according to claim 1, wherein the rechargeable lithium battery supplies power to the control circuit of the smart glove.

6. The smart glove according to claim 1, characterized in that: the controller is composed of modules such as a Bluetooth transceiver circuit, a charging circuit, a main control circuit, etc., and is used to receive and process user data, while controlling the LED display 111 Display and store user-defined patterns; the Bluetooth transceiver circuit is used to communicate with the mobile phone, receive data and control commands issued by the mobile phone APP, and forward the data to the main control circuit; the charging circuit is used to control The charging of the rechargeable lithium battery; the main control circuit parses the data forwarded by the Bluetooth transceiver circuit and controls it according to user commands, and at the same time sends the decoded display data to the LED driver.

For example, the user sends a favorite picture to the glove through the Bluetooth, and the glove can display the picture immediately after receiving the picture. Another example is the user in the riding, When the bicycle turns, the rider can send steering commands to the gloves, gloves give directions to turn left or right according to APP commands; or issue emergency warning signals when in danger, etc.

7. The smart glove according to claim 1, characterized in that: the LED display 111 is composed of LED lamp beads, which can display time information, warning characters, direction characters, patterns, etc.

8. The smart glove according to claim 1, characterized in that: the drive circuit driver of the LED display screen 111 converts the display data received from the main control circuit into an LED display sequence, Drive each lamp bead, these lamp beads are displayed in accordance with the timing requirements, you can achieve the effects of patterns and texts.

I claim:

1. A smart glove relates to a smart glove that can be used indoors and outdoors, including a glove body, which includes a wrist, a palm, and a finger. On the back of the wrist, there are a switch button, a charging interface, and a control box. The control box contains a rechargeable lithium battery and a controller. The charging interface is electrically connected to the lithium battery in the control box; an LED display is installed on the back of the palm, and the inside of the LED display is electrically connected to the driver of the LED display; after wearing the finger The part can wrap all the fingers or part of the fingers to protect the skin; on the one hand, the present invention can play a warning role when the user is walking or riding, improving the safety of travel, and on the other hand, it can play a role Display and publicity role.

2. The smart glove according to claim 1, characterized in that: the glove body is composed of multi-layer materials such as glove surface cloth/leather and inner layer woolen cotton.

3. The smart glove according to claim 1, characterized in that: the switch button is used to control the on/off of the entire smart glove and the switching of the LED display pattern; the switching of the LED display pattern refers to through the switch Press the button to select a variety of patterns in the functional mode of the smart glove; the functional modes include warning, propaganda and atmosphere; the user selects the functional mode through the mobile phone APP, and customizes the multiple pattern types in this mode, For the user to enter the pattern selection of the LED display screen through the switch button.

4. The smart glove according to claim 1, wherein the charging interface is used to connect an external power source to complete the charging of the rechargeable lithium battery, and at the same time, data can be sent and received.

5. The smart glove according to claim 1, wherein the rechargeable lithium battery supplies power to the control circuit of the smart glove.

6. The smart glove according to claim 1, characterized in that: the controller is composed of modules such as a Bluetooth transceiver circuit, a charging circuit, a main control circuit, etc., for receiving and processing user data, and at the same time controlling the display of the LED display, And store user-defined patterns; the Bluetooth transceiver circuit is used to communicate with the mobile phone, receive data and control commands issued by the mobile phone APP, and forward the data to the main control circuit; the charging circuit is used to control the The charging of the rechargeable lithium battery; the main control circuit parses the data forwarded by the Bluetooth transceiver circuit and controls it according to user commands, and at the same time sends the decoded display data to the LED drive circuit.

7. The smart glove according to claim 1, wherein the LED display screen is composed of LED lamp beads, which can display time information, warning characters, direction characters, patterns, and the like.

8. The smart glove according to claim 1, wherein the driving circuit of the LED display screen converts the display data received from the main control circuit into an LED display sequence, and then drives each of the LED display screens, LED lamp beads, to achieve the effect of displaying text and patterns.

9. The smart glove according to claim 8, characterized in that: when the user is walking or cycling on the roadside and other outdoor activities, the user can set the warning mode through the mobile phone APP, and select the warning picture through the switch button; At the exhibition, users can set up a publicity mode through the mobile app, and users wear gloves for mobile publicity; in various dating venues, users can wear gloves for self-display.
